(19) United States
(12) Patent Application Publication
(10) Pub. No.: US 2014/0000549 A1
(43) Pub. Date: Jan. 2, 2014

(54) COMPRESSION RING FOR AN ENGINE

(71) Applicants: Frank Matthew Graczyk, Darien, IL (US); Aaron Gamache Foege, Westmont, IL (US); Farhan Ferozali Devani, Morton Grove, IL (US); Edward John Cryer, Homer Glen, IL (US); David Edward Burrell Stone, Indianapolis, IN (US)

(72) Inventors: Frank Matthew Graczyk, Darien, IL (US); Aaron Gamache Foege, Westmont, IL (US); Farhan Ferozali Devani, Morton Grove, IL (US); Edward John Cryer, Homer Glen, IL (US); David Edward Burrell Stone, Indianapolis, IN (US)

(21) Appl. No.: 13/538,069

(22) Filed: Jun. 29, 2012

(51) Int. Cl. F02F 5/00; F16J 9/26; F16J 9/00; F16J 9/20; F02F 3/00; F02F 1/00

(52) U.S. Cl. 123/193.4; 92/169.1; 277/434; 277/489

(57) ABSTRACT

A compression ring for an engine is disclosed. The compression ring may have a cylindrical body having an outer surface, and a central opening formed within the cylindrical body and concentric with the outer surface of the cylindrical body. The cylindrical body may have a radial dimension from the central opening to the outer surface that is about 1.1 to 1.3 times as long as an axial dimension of the cylindrical body.

### TECHNICAL FIELD

The present disclosure relates generally to an engine and, more particularly, to an engine having a compression ring.

### BACKGROUND

Conventional two-stroke engines include a cylinder, a cylinder head connected to the cylinder to at least partially form a combustion chamber, and a piston disposed within the combustion chamber. At least one port, for example an intake port, is formed within a liner of the cylinder to allow gas exchange with the combustion chamber each time the piston moves downward within the cylinder. The piston is provided with annular grooves and rings disposed within the grooves.

The piston rings perform several different functions, including sealing a radial gap between the piston and cylinder liner so as to maintain high gas pressures within the combustion chamber. Other functions performed by piston rings include maintaining lubrication between the piston and cylinder liner, transferring heat in order to cool the piston, and maintaining an axial position of the piston relative to the cylinder liner during reciprocation of the piston.

There are two general classifications of piston rings: compression rings and oil control rings. Compression rings are typically found towards the top of the piston, nearest the combustion chamber. The primary purpose of compression rings is to prevent gases from leaking by the piston, called blowby, during the compression and power strokes of the piston. Oil control rings are designed to bring oil to the cylinder liner during the upstroke of the piston for proper lubrication, and push excess oil to the bottom of the cylinder during the piston's down stroke. Compression rings can provide secondary oil control and oil control rings can provide secondary blowby control.

A number of different problems can arise if the piston rings do not successfully seal radial gaps between the piston and the cylinder liner. Blowby of highly pressurized gases from the combustion chamber to the crankcase below the piston can decrease engine performance and contaminate engine oil. If an inadequate amount of oil is distributed along the cylinder liner on the upstroke, liner scuffing, scraping and other types of damage can subsequently occur. If excess oil is left behind on the cylinder liner after the down stroke it can combust and result in levels of particulate emission that exceed government regulatory standards. Particulate formation can also be harmful to the engine.

The disclosed engine is directed to overcoming one or more of the problems set forth above.

### SUMMARY

In one aspect, the present disclosure is directed to a piston ring. The piston ring may include a cylindrical body having an outer surface, and a central opening formed within the cylindrical body and concentric with the outer surface of the cylindrical body. The piston ring may further include a radial dimension of the cylindrical body from the central opening to the outer surface that is about 1.1 to 1.3 times as long as an axial dimension of the cylindrical body.

In another aspect, the present disclosure is directed to a piston assembly. The piston assembly may include a cylinder liner, a piston crown disposed within the cylinder liner, and a compression ring disposed within a groove of the piston crown. Additionally, a radial width of the compression ring may be about 1.1 to 1.3 times as long as an axial thickness of the compression ring, and the cylinder liner may have a surface finish with: a RK of about 40 to 100 microinches, a Rpk maximum of about 50 microinches, and a Rvk of about 32 to 100 microinches.

### BRIEF DESCRIPTION OF THE DRAWINGS

FIG. 1 is a cross-sectional illustration of an exemplary disclosed engine;

FIG. 2 is a diagrammatic illustration of an exemplary disclosed piston and compression piston ring that may be used in conjunction with the engine of FIG. 1;

FIG. 3 is a diagrammatic illustration providing an alternate view of the compression ring of FIG. 2; and

FIGS. 4-7 are diagrammatic illustrations of exemplary disclosed piston rings that may be used in conjunction with the piston and compression ring of FIG. 2.

### DETAILED DESCRIPTION

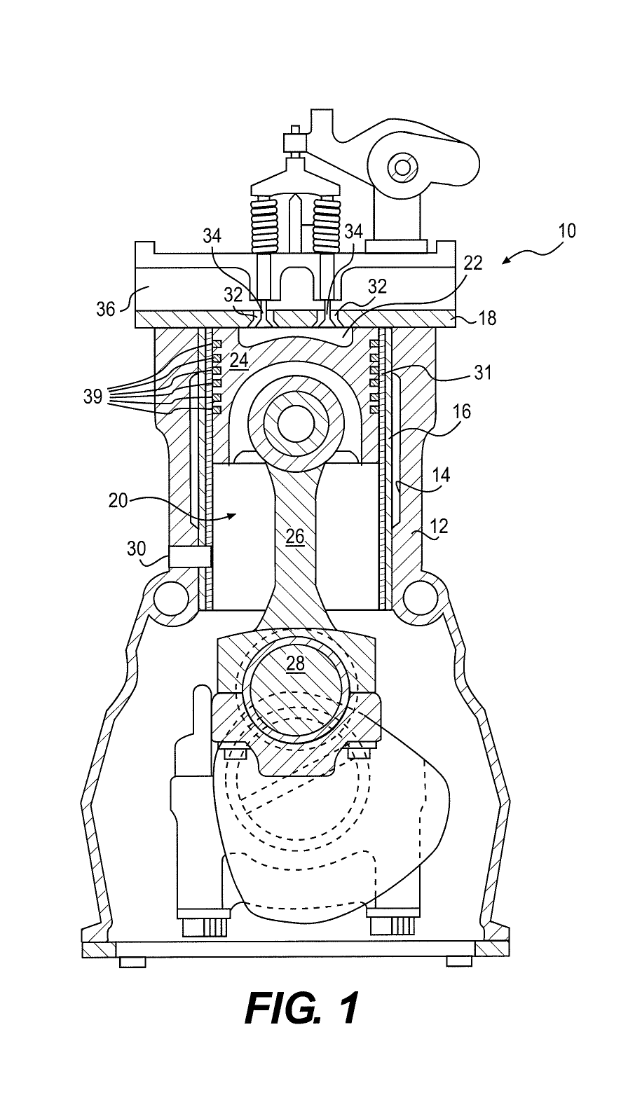

An exemplary internal combustion engine 10 is illustrated in FIG. 1. Engine 10 is depicted and described as a two-stroke diesel engine. However, it is contemplated that engine 10 may be another type of internal combustion engine such as, for example, a four-stroke diesel engine, a two- or four-stroke gasoline engine, or a two- or four-stroke gaseous fuel-powered engine. Engine 10 may include, among other things, an engine block 12 that at least partially defines a cylinder 14, a liner 16 disposed within cylinder 14, and a cylinder head 18 connected to engine block 12 to close off an end of liner 16. A piston 20 may be slidably disposed within liner 16 and, together with liner 16 and cylinder head 18, define a combustion chamber 22. It is contemplated that the engine 10 may include any number of combustion chambers 22 and that combustion chambers 22 may be disposed in an “in-line” configuration (shown in FIG. 1), in a “V” configuration, in an opposing-piston configuration, or in any other conventional configuration.

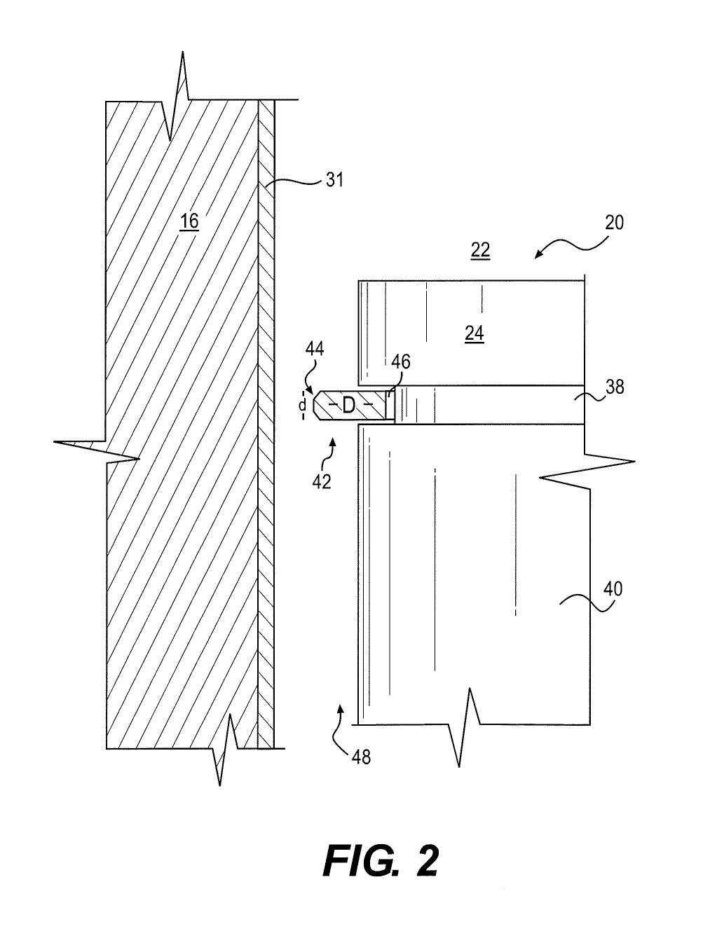

As shown in FIGS. 1 and 2, liner 16 of cylinder 14 may have a finish 31 designed to maintain a desired thickness of oil on an internal surface thereof In one embodiment, the desired thickness of the oil film may be about 0.0001 to 0.001 inches. In this embodiment, finish 31 may have a core/kernel (Rk) range of about 40 to 100 microinches, a peak height (Rpk) maximum of about 50 microinches, and a valley depth (Rvk) range of about 32 to 100 microinches. Finish 31 may be used in conjunction with a specific set of piston rings located on piston 20.

Piston 20 may be configured to reciprocate between a bottom-dead-center (BDC) or lower-most position within liner 16, and a top-dead-center (TDC) or upper-most position. In particular, piston 20 may be an assembly that includes a piston crown 24 pivotally connected to a rod 26, which may in turn be pivotally connected to a crankshaft 28. Crankshaft 28 of engine 10 may be rotatably disposed within engine block 12 and each piston 20 coupled to crankshaft 28 by rod 26 so that a sliding motion of each piston 20 within liner 16 results in a rotation of crankshaft 28. Similarly, a rotation of crankshaft 28 may result in a sliding motion of piston 20. As crankshaft 28 rotates through about 180 degrees, piston crown 24 and connected rod 26 may move through one full stroke between BDC and TDC. Engine 10, being a two-stroke engine, may have a complete cycle that includes a power/exhaust/intake stroke (TDC to BDC) and an intake/compression stroke (BDC to TDC).

During a final phase of the power/exhaust/intake stroke described above, air may be drawn into combustion chamber 22 via one or more gas exchange ports (e.g., intake ports) 30 located within liner 16. In particular, as piston 20 moves downward within liner 16, a position will eventually be reached at which ports 30 are no longer blocked by piston 20 and instead are fluidly communicated with combustion chamber 22. When intake ports 30 are in fluid communication with combustion chamber 22 and a pressure of air at intake ports 30 is greater than a pressure within combustion chamber 22, air will pass through intake ports 30 into combustion chamber 22. Fuel may be mixed with the air before, during, or after the air is drawn into combustion chamber 22.

During the beginning of the intake/compression stroke described above, air may still be entering combustion chamber 22 via intake port 30 and piston 20 may be starting its upward stroke to mix the fuel and air within combustion chamber 22. Eventually, port 30 may be blocked by piston 20 and further upward motion of piston 20 may compress the mixture. As the mixture within combustion chamber 22 is compressed, a temperature of the mixture will increase. Eventually, the pressure and temperature of the mixture will reach a point at which the mixture combusts, resulting in a release of chemical energy in the form of temperature and pressure spikes within combustion chamber 22.

During a first phase of the power/exhaust/intake stroke, the pressure spike within combustion chamber 22 may force piston 20 downward, thereby imparting mechanical power to crankshaft 28. At a particular point during this downward travel, one or more gas exchange ports (e.g., exhaust ports) 32 located within cylinder head 18 may open to allow pressurized exhaust within combustion chamber 22 to exit. In particular, as piston 20 moves downward within liner 16, a position will eventually be reached at which exhaust valves 34 move to fluidly communicate combustion chamber 22 with exhaust ports 32. When combustion chamber 22 is in fluid communication with exhaust ports 32 and a pressure of exhaust in combustion chamber 22 is greater than a pressure at exhaust ports 32, exhaust will pass from combustion chamber 22 through exhaust ports 32 into an exhaust manifold 36. In the disclosed embodiment, movement of exhaust valves 34 may be cyclical and controlled by way of a cam (not shown) that is mechanically connected to crankshaft 28. It is contemplated, however, that movement of exhaust valves 34 may be controlled in any other conventional manner, as desired. It is also contemplated that exhaust ports 32 could alternatively be located within cylinder liner 16, if desired, such as in a loop scavenged two-cycle engine.

As shown in FIGS. 1 and 2, piston crown 24 of piston 20 may have a generally cylindrical structure with one or more grooves 38 formed within an outer annular surface 40. Grooves 38 may be configured to receive any number of piston rings including, for example, one or more oil or scraper rings, one or more compression rings, and/or another type of piston ring known in the art. An exemplary piston ring set 39 is depicted in FIG. 1 and includes six rings, four of which may be compression rings (e.g., the upper four rings). The remaining rings may be oil control rings (e.g., the lower two rings).

FIG. 2 illustrates only an upper portion of piston 20 that includes one exemplary compression ring 42. Ring 42 may have a cylindrical body with a central opening 46 and an outer annular ring surface 44 that is generally concentric with central opening 46. Central opening 46 may have a diameter greater than an inner diameter of the associated groove 38, but less than an outer diameter of piston crown 24 such that ring 42 may be retained at least partially within groove 38 by a difference in diameters. A radial dimension or width (D) of ring 42 may be about 0.225 to 0.245 inches or about 1.1 to 1.3 times as long as an axial dimension or thickness (d) of ring 42. In the disclosed embodiment, d may be about 0.1875 to 0.1900 inches.

The dimensions D and d may afford a desirable degree of flexibility to ring 42. In one embodiment, a desirable degree of flexibility may be such that ring 42 is rigid enough to inhibit buckling during operation, but flexible enough to accommodate heat and/or pressure induced distortion during operation of engine 10. Specifically, dimensions D and d may enable ring 42 to undergo substantially uniform distortion in a radial direction. In one embodiment, ring 42 may extend to the wall of cylinder 14 and conform to the same. The diameter of cylinder 14 may be about 9.060 inches in diameter. In this embodiment, ring 42 may be designed to be radially distorted by heat of about 400 to 900 degrees Celsius, and/or combustion pressure of about 1,500 to 2,000 psi.

Piston crown 24 and liner 16 may be separated by radial gap 48. During the TDC to BDC stroke of piston 20, the combustion pressure within combustion chamber 22 may distort and extend ring 42 radially across radial gap 48, such that ring surface 44 extends against finish 31. The flexibility of ring 42 may allow ring 42 to conform to the shape of liner 16 (including the various contour fluctuations therein). By contacting and conforming to liner 16, ring 42 may seal against blowby gases and help to remove excess oil from finish 31 of liner 16.

Ring 42 may be made of a stainless steel base material, which may have been pre-stressed to improve ring fatigue strength and fracture sensitivity. Ring surface 44 may be generally asymmetrically barrel-shaped in order to generate a uniform and controlled oil layer on finish 31. Ring surface 44 may be face-coated with a ceramic chrome plating to better sustain long-term operation of ring 42. Additionally, ring 42 may be chrome side-plated for greater wear resistance.

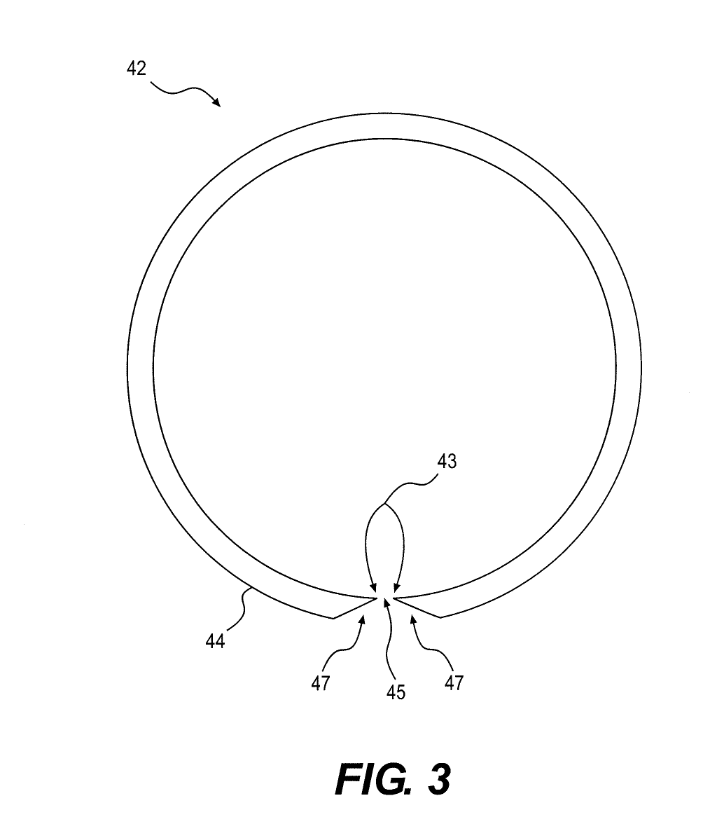

FIG. 3 illustrates ring 42 with elements that each of the hereafter-referenced rings may also have in common. Some of these common elements may include ends 43 that are spaced apart by a gap 45, as well as a ring tip protrusion relief 47 located at each end 43. Gap 45 may be generally aligned with port 30 so as to avoid ring tip protrusion into port 30 during the TDC to BDC and BDC to TDC strokes of piston 20, which ring tip protrusion may damage port 30 and/or ring 42. Additionally, gap 45 in ring 42 may facilitate the assembly of ring 42 within groove 38 by providing the spacing and flexibility necessary to contort ring 42 such that it may slip into groove 38. Surface tip protrusion reliefs 47 may act as additional measures to inhibit damaging of port 30. In particular, the surface tip protrusion relief 47 may be such that no portion of ring 42 enters into port 30.

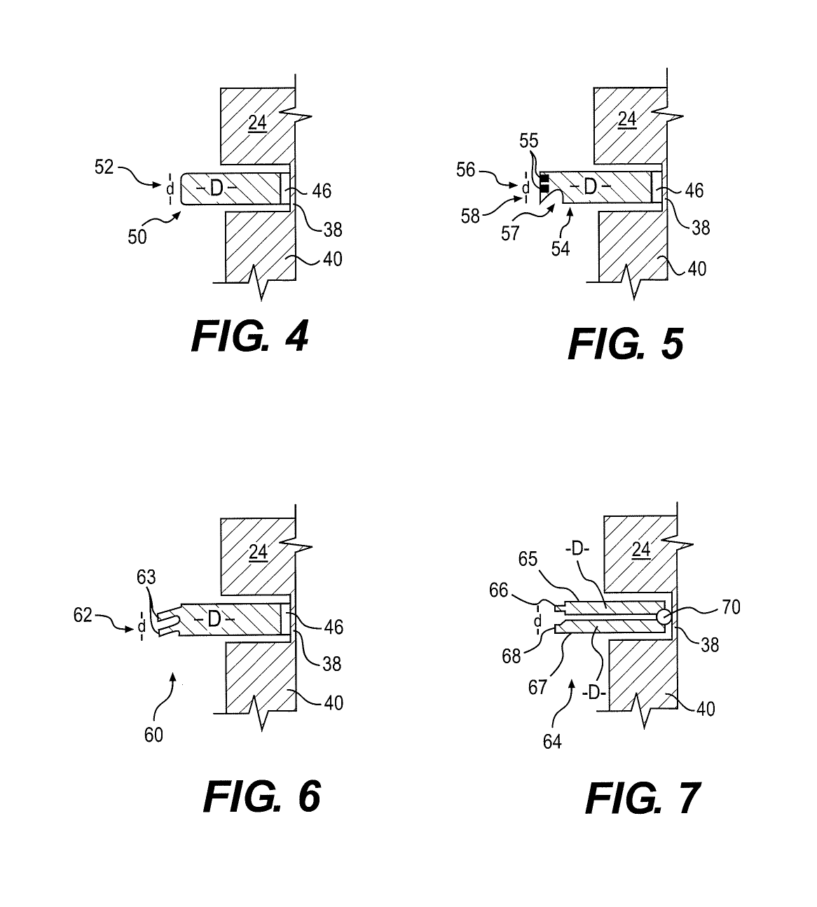

FIG. 4 illustrates another embodiment of a compression ring, ring 50. Ring 50 may be used together with, or separate from, ring 42. For example, ring 50 may be in a secondary location below ring 42. Ring 50 may have a cylindrical body with a central opening 46 and an outer annular ring surface 52 that is generally concentric with central opening 46. Central opening 46 may have a diameter greater than an inner diameter of the associated groove 38, but less than an outer diameter of piston crown 24 such that ring 50 may be retained at least partially within groove 38 by a difference in diameters. The radial dimension or width (D) of ring 50 may be about 0.290 to 0.305 inches or about 1.5 to 1.7 times as long as an axial dimension or thickness (d) of ring 50. In the disclosed embodiment, d may be about 0.1850 to 0.1885 inches.

Ring 50 may be made of a ductile iron base material. Ring surface 52 may have a symmetrical barrel-shape in order to generate a uniform and controlled oil layer on finish 31. Ring surface 52 may be face-coated with ceramic chrome plating to better sustain long-term operation of ring 50. It is contemplated that two of rings 50 may be used together in the same ring set 39, if desired.

FIG. 5 illustrates another embodiment of a compression ring, ring 54. Ring 54 may be used together with, or separate from, the aforementioned rings. For example, ring 54 may be in a secondary location below ring 42. Ring 54 may have a cylindrical body with a central opening 46 and an annular outer ring surface 56 that is generally concentric with central opening 46. Central opening 46 may have a diameter greater than an inner diameter of the associated groove 38, but less than an outer diameter of piston crown 24 such that ring 54 may be retained at least partially within groove 38 by a difference in diameters. The radial dimension or width (D) of ring 54 may be about 0.290 to 0.305 inches or about 1.5 to 1.7 times as long as an axial dimension or thickness (d) of ring 54. In the disclosed embodiment, d may be between about 0.1850 and 0.1865 inches.

Ring 54 may be made of a ductile iron base material. Ring surface 56 may include a napier-style hooked scraper 58, two annular grooves 55 and a recessed channel 57. Scraper 58 and grooves 55 may provide for aggressive oil scraping during the TDC to BDC stroke of piston 20. Each of grooves 55 may be filled with an iron-based material and have a width of about 0.017 to 0.022 inches and a depth of about 0.025 to 0.035 inches. Grooves 55 may be spaced apart by about 0.018 to 0.022 inches. Grooves 55 may be situated such that they are generally centered on the remaining portion of ring surface 56 that is uninterrupted by scraper 58. Channel 57 may help trap the scraped oil and deliver it below ports 30. Channel 57 may have a width of about 0.032 to 0.048 inches, a height of about 0.065 to 0.085 inches, and a radius of about 0.030 inches. Ring surface 56 may be face-coated with an iron-based material to better sustain long-term operation of ring 50.

FIG. 6 illustrates an embodiment of an oil control ring, ring 60. Ring 60 may be used together with, or separate from, the aforementioned rings. Ring 60 may be a traditional self-energized iron double-hook oil control ring. Ring 60 may have a cylindrical body with a central opening 46 and an annular outer ring surface 62 that is generally concentric with central opening 46. Central opening 46 may have a diameter greater than an inner diameter of the associated groove 38, but less than an outer diameter of piston crown 24 such that ring 60 may be retained at least partially within groove 38 by a difference in diameters. The radial dimension or width (D) of ring 60 may be about 0.290 to 0.305 inches or about 1.1 to 1.2 times as long as an axial dimension or thickness (d) of ring 60. In the disclosed embodiment, d may be about 0.247 to 0.249 inches.

Ring 60 may include hooks 63. Hooks 63 may each have a width of about 0.125 inches and a radius of about 0.033 inches, and may be configured to engage surface finish 31 at about a 30° angle relative to an axis of piston 20. Hooks 63 may point toward the base of piston 20 (e.g., toward rod 26), when assembled. Although ring 60 is primarily designed to function as an oil control ring, it may also assist in preventing blowby as well as incoming air from ports 30 from entering the crankcase (not shown) of engine 10.

FIG. 7 illustrates another embodiment of an oil control ring, ring 64. Ring 64 may be used together with, or separate from, the aforementioned rings. Ring 64 may be a derivative of a traditional spring-energized iron double rail oil control ring. Ring 64 may have a cylindrical body and may include multiple rails (e.g., two rails), rails 65 and 67, that are configured for scraping excess oil from finish 31 of liner 16. Rail 65 may include ring surface 66 that has a symmetrical barrel-shaped face. Rail 67 may include a ring surface 68 that has an asymmetrical barrel-shaped face. The radial dimension or width (D) of ring 64 may be about 0.210 to 0.225 inches or about 0.84 to 0.85 times as long as an axial dimension or thickness (d) of ring 64. In the disclosed embodiment, d may be between about 0.248 and 0.249 inches.

Ring 64 may further include spring 70. Spring 70 may act to extend the diameter of ring surfaces 66 and 68 such that the diameter of ring 64 exceeds that of cylinder 14. Consequently, after ring 64 is placed in axial alignment with groove 38, ring 64 may expand and contact finish 31 of liner 16 with spring force.

### INDUSTRIAL APPLICABILITY

The disclosed piston rings and cylinder liner finish 31 may be used in any internal combustion engine where a reduction in particulate emissions and combustion gas blowby is desired. In particular, the disclosed piston rings and cylinder liner finish 31 may work in concert to help maintain a desired oil film thickness on finish 31, and to help prevent combustion gas blowby from entering the crankcase. Ring 42 may be designed so as to be able to distort, and otherwise extend, in a radial direction during normal engine operation. In so doing, ring 42 may conform to the shape of cylinder 14 and come into direct contact with finish 31. The function of finish 31 and rings 42, 50, 54, 60 and 64 will now be explained.

As illustrated in FIG. 1, finish 31 may be a surface finish on liner 16. Finish 31 may include contours designed to maintain an oil film thickness of between about 0.0001 and 0.001 inches when utilized in conjunction with the disclosed set of piston rings.

For example, ring 42 may be designed in such a manner so as to be radially extendible when exposed to combustion pressures and/or combustion temperatures generated in combustion chamber 22. By so doing, ring 42 may help block blowby gases from entering the crankcase. Additionally, the interaction of a radially extended ring 42 with finish 31 may scrape excess oil away from liner 16, leaving behind a desirable oil film thickness. For example, the contours of finish 31 may trap an oil film thickness of about 0.0001 to 0.001 inches while allowing oil in excess of 0.001 inches in oil film thickness to be scraped away by ring 42. By uniformly scraping excess oil from liner 16, ring 42 may help limit the amount of excess oil that is left behind and incinerated during the TDC to BDC stroke of piston 20. Limiting the amount of excess oil that is burned proportionally limits the amount of particulate emissions generated from operation of engine 10.

The disclosed design of ring 42 may help reduce friction, scuffing and damage generated at liner 16 by maintaining an adequate amount of lubricating oil on finish 31. Additionally, because only contact portion 44 of ring 42 may contact liner 16, the amount of friction generated therebetween may be low, while still allowing ring 42 to radially position piston crown 24 within liner 16.

To install each of the six aforementioned exemplary piston rings within groove 38, the ends 43 of the rings may first be pushed apart from each other to temporarily enlarge the diameter of central opening 46. While the diameter of central opening 46 is temporarily enlarged, the rings may be placed over piston crown 24 and into axial alignment with groove 38. The ends 43 of the rings may then be released, allowing the rings to flex into and be retained within groove 38 by the now smaller diameter of central opening 46.

Given their relatively simple design and constitution, finish 31 and rings 42, 50, 54, 60 and 64 may be easily fitted to any internal combustion engine 10. Specifically, older engines may be retrofitted with liner 16 including finish 31 and rings 42, 50, 54, 60 and 64 if the benefits of such are desired. Regulatory standards may require that an older or current model of an engine 10 be modified so as to decrease the engine's particulate emissions. In such situations, retrofitting engine 10 with liner 16 including finish 31 and rings 42, 50, 54, 60 and 64 may resolve the particulate emission-related concerns for engine 10.

It will be apparent to those skilled in the art that various modifications and variations can be made to the disclosed piston rings and cylinder liner without departing from the scope of the disclosure. Other embodiments of the piston rings and cylinder liner will be apparent to those skilled in the art from consideration of the specification and practice of the piston rings and cylinder liner disclosed herein. It is intended that the specification and examples be considered as exemplary only, with a true scope of the disclosure being indicated by the following claims and their equivalents.

1. A piston ring, comprising:
a cylindrical body having an outer surface; and
a central opening formed within the cylindrical body and concentric with the outer surface of the cylindrical body,
wherein the outer surface of the cylindrical body includes a napier-style hooked scraper and at least one annular groove filled with an iron-based material.

2. The piston ring of claim 1, wherein a radial dimension of the cylindrical body is about 1.5 to 1.7 times as long as an axial dimension of the cylindrical body.

3. The piston ring of claim 1, wherein the cylindrical body is made of a stainless steel base material.

4. The piston ring of claim 1, wherein the cylindrical body is barrel-shaped.

5. The piston ring of claim 1, wherein the cylindrical body includes two ends separated by a gap, each of the two ends having a tip protrusion relief.

6. A piston assembly, comprising:
a cylinder liner;
a piston crown disposed within the cylinder liner;
a compression ring disposed within a groove of the piston crown, wherein a radial width of the compression ring is about 1.5 to 1.7 times as long as an axial thickness of the compression ring; and
the compression ring includes a cylindrical body having an outer surface; and
a central opening formed within the cylindrical body and concentric with the outer surface of the cylindrical body;
wherein the outer surface of the cylindrical body includes a napier-style hooked scraper and at least one annular groove filled with an iron-based material.

7. The piston assembly of claim 6, wherein the groove of the piston crown is an uppermost groove in the piston crown.

8. The piston assembly of claim 6, wherein the compression ring is configured to expand against, and form a seal with, the cylinder liner at a peak cylinder pressure of about 1,500 to 2,000 psi.

9. The piston assembly of claim 6, wherein the compression ring is one of a set of at least six piston rings, including:
at least four compression rings; and
at least two oil control rings.

10. The piston assembly of claim 9, wherein:
at least two of the at least four compression rings are barrel-shaped; and
a radial width of the at least two compression rings is about 1.5 to 1.7 times as long as an axial thickness of the at least two compression rings.

11. The piston assembly of claim 10, wherein ends of the at least six piston rings are separated by a gap, and have tip protrusion reliefs.

12. The piston assembly of claim 10, wherein the at least two of the at least four compression rings are made of a ductile iron base material.

13. The piston assembly of claim 6,
wherein:
the outer surface of the cylindrical body includes at least one annular groove filled with iron-based material, and the at least one annular groove is approximately centered on a remaining portion of the outer surface uninterrupted by the napier-style hooked scraper .

14. The piston assembly of claim 13, wherein the napier-style hooked scraper ring has a cylindrical body with two ends separated by a gap, each of the two ends having a tip protrusion relief.

15. The piston assembly of claim 14, wherein the cylindrical body is made of a ductile iron base material.

16. The piston assembly of claim 9, wherein:
at least one of the at least two oil control rings includes a double-hook ring; and
a radial width of the double-hook ring is about 1.1 to 1.2 times as long as an axial thickness of the double-hook ring.

17. The piston assembly of claim 16, wherein the double-hook ring includes a cylindrical body having two ends separated by a gap, each of the two ends having a tip protrusion relief.

18. The piston assembly of claim 9, wherein:
at least one of the at least two oil control rings includes a spring-energized set of rails; and
a radial width of the at least one of the at least two oil control rings is about 0.84 to 0.85 times as long as an axial thickness of the at least one of the at least two oil control rings.

19. The piston assembly of claim 18, wherein the at least one of the at least two oil control rings includes a cylindrical body with two ends separated by a gap, each of the two ends having a tip protrusion relief.

20. An internal combustion engine, comprising:
an engine block at least partially defining a cylinder;
a liner disposed within the cylinder;
a cylinder head connected to the engine block and together with the liner at least partially forming a combustion chamber;
a piston slidably disposed within the liner and having a plurality of annular grooves formed within an outer surface; and
a set of piston rings received within the plurality of annular grooves, the set of piston rings including:
a first compression ring having a radial width of about 1.1 to 1.3 times as long as an axial thickness; and
a second compression ring, the second compression ring including a cylindrical body having a central opening and an annular outer ring surface generally concentric with the central opening, and the annular outer ring surface including:
a napier-style hooked scraper having a radial width about 1.5 to 1.7 times as long as an axial thickness; and
at least one annular groove located on a remaining portion of the annular outer ring surface uninterrupted by the napier-style hooked scraper.
